(19) United States
(12) Patent Application Publication
(10) Pub. No.: US 2008/0173246 A1
(43) Pub. Date: Jul. 24, 2008

(54) Pet watering apparatus and method

(76) Inventor: Gerald L. Barkdoll, Rockville, MD (US)

Correspondence Address: BERENATO, WHITE & STAVISH, LLC, 6550 ROCK SPRING DRIVE, SUITE 240, BETHESDA, MD, 20817, US

(21) Appl. No.: 11/656,962

(22) Filed: Jan. 24, 2007

(51) Int. Cl. A01K 7/00

(52) U.S. Cl. 119/74

(57) ABSTRACT

The present invention relates to a pet watering apparatus for use with a wash basin having a spigot. The pet watering apparatus includes a platform configured for spanning the wash basin, and a watering bowl. The platform has an opening extending through a central portion thereof The watering bowl is configured for being received in the opening, and is removeably secured in the opening and aligned with the spigot for collecting water therein so that a pet may drink therefrom. A method of watering a pet using the disclosed apparatus is also disclosed.

### FIELD OF THE INVENTION

The present invention relates to a pet watering apparatus for use with a wash basin having a spigot. The pet watering apparatus includes a platform configured for spanning the wash basin, and a watering bowl. The platform has an opening extending through a central portion thereof. The watering bowl is configured for being received in the opening, and is removeably secured in the opening and aligned with the spigot for collecting water therein so that a pet may drink therefrom. A method of watering a pet using the disclosed apparatus is also disclosed.

### BACKGROUND OF THE INVENTION

Domesticated pets, and particularly cats, have proven to be remarkably persnickety and variable water drinkers although adequate water consumption is recognized as a key component of good feline health. Many pets insist on a continuous supply of fresh water rather than water that has become stale. Some pets will drink from a simple water bowl while others insist on running water or water that is frequently replaced. Many pets demonstrate different preferences at different times and over time.

To provide fresh water, some conventional designs provide a bowl that is connected by a pipe or a hose to a central pressurized water supply. Some such designs respond to the weight of the animal to open a valve to produce a flow of water into a bowl, tank of trough. Other designs include sensors that sense the proximity of the animal, and then electronically open a valve to produce the flow of water. Another design includes a controlled timing device that allows water to flow at established time periods. Many conventional systems are designed for larger animals and for use outdoors, where spillage is not a problem. In addition, such designs require that the units be connected to a pressurized water supply, and are therefore subject to failure of their electrical or mechanical components.

Some conventional systems have been developed which include drinking bowls and fountains designed to meet the needs of relatively small pets desiring running water sources. Such systems typically include a water storage reservoir, a pump to circulate the water, and a power source. However, they are subject to the failure of the mechanical pump and motor. Further, systems driven by batteries require periodic battery replacement. In addition, they are often noisy during operation, particularly when the water supply is running low, which is annoying to most pet owners.

Systems with water reservoirs require monitoring and replenishment of the water supply. The water reservoir must be periodically filled, usually at a location remote form their placement during operation. Alternatively, a user may fill the water reservoir using some other water container. In either case, maintaining an adequate amount of water in the reservoir requires time and effort, and may lead to water spillage during the process. Moreover, the pet owner must typically stoop and bend to reach and fill the water reservoir, which may be difficult or impossible for infirm owners, or may cause injury to the owner's back, arms, shoulders or necks.

Water contained in water reservoirs of circulating systems also becomes contaminated as the pet's saliva mixes with the water, and as airborne contaminants fall into the water over time. Some systems include a filter. However, such filters are prone to clogging, or must be replaced. Thus, such systems are not efficient or effective.

The availability of space required for drinking systems with attached water reservoirs, as well as the overall weight of filled units and associated difficulty in moving them, necessitate that they remain relatively small. As such, such systems must be manually refilled frequently.

A substantial number of small pet owners report that their pets, and particularly cats, demonstrate a preference for jumping up on bathroom or kitchen counters and attempting to drink from an open spigot or from water in the wash bowl. In both cases, the pet must assume an awkward position to reach the water, or risk getting their feet or paws wet, and some pets lose interest in this otherwise superior source of fresh water. In those instances where the small pet manages to drink water left in the wash basin, it may be exposed to residues of the harsh and potentially injurious cleaning chemicals often used to clean bathroom fixtures. Moreover, owners that permit their pets to drink from a bathroom sink often find that use of the sink for their own hygiene activities, such as hands and face washing and teeth brushing, are either denied or such use must be preceded by sink cleaning to remove accumulated pet saliva residues.

Although devices have been proposed which span the open portion of a sink, such as cutting, washing or draining boards, or cages for draining vegetables, kitchen utensils, dishes and the like, such devices are designed to allow water to drain away from the food or other material disposed thereon as opposed to retaining water.

Thus, conventional pet watering systems and devices suffer from various problems. Some conventional devices contain moving mechanical parts and electrical components, both of which are subject to failure. Some designs require an uninterrupted supply of electrical current. Some designs require that the user stoop, lift and carry the unit to provide or/or replenish the supply of water; moreover, the relatively small size of water reservoirs necessitates constant monitoring and frequent refilling. Many designs are prone to becoming contaminated with bacteria or other impurities. Many pets avoid drinking from an open spigot due to the necessity of assuming an awkward body position, or the likelihood that they will get their snout, feet or paws wet; small pets are also prone to being exposed to harsh and potentially harmful cleaning chemicals used to clean bathroom fixtures. Moreover, sinks from which a pet attempts to drink require frequent cleaning, especially if the owner uses the sink for his or her own hygienic activities.

Therefore, there is a need for a pet watering apparatus which overcomes some or all of the above-noted deficiencies, which provides small pets with a wholesome supply of potable water and accommodates the diverse and changing drinking preferences of small pets, such as cats.

### SUMMARY OF THE INVENTION

The present invention relates to a platform that bridges across the sides of a conventional bathtub or bathroom, kitchen or washroom sink, and supports small pets such as dogs, cats, rabbits, guinea pigs, etc., so that the small pet can drink through a variety of options including drinking from an open faucet or from a water bowl supported by the platform and periodically or continuously filled from the faucet. The center portion of the platform supports a water bowl and is both sunken and perforated to catch any water that overflows when the water in the water bowl is being replaced or refilled from the spigot, or the water in the water bowl is splashed when the pet is drinking. The perforations in the sunken portion allow the waste, excess or splashed water to drop into the tub or sink and flow down the sink drain.

The water bowl that is supported and held in place by the platform is a separate component, thus allowing it to be removed and washed in a dishwasher or by other means. This avoids the potential that the pet will drink water that is laced with the injurious chemicals used in routine bowl and tub cleaning when the pet drinks directly from water in the sink or tub. Removing the water bowl also allows the pet to drink directly from a stream of water from the spigot without having to assume an uncomfortable position or drinking in a head down position from the sink.

The area of the platform immediately adjacent to the sunken portion is also perforated to catch any water splashed beyond the sunken area. The platform is strengthened with ribs on top and/or bottom to prevent excessive deformation from the weight of one or more pets.

A portion of the platform is shaped to fit around the faucet assembly of the bathroom sink to assure that the platform does not slide side-to-side. In addition, the outer portions of the platform preferably contain a series of holes to accommodate various placements of pins that extend below the platform and engage the sides of the tub or sink to prevent the platform from sliding off of the side edges of the tub or sink. The top surface of the platform may be textured or coated to provide a non-slip surface for the pets. The bottom surface of the platform may be textured or coated with a non skid material to further assure that the platform does not slide with respect to the supporting sink.

A pet watering apparatus according to an embodiment of the present invention includes a platform configured for spanning a wash basin, and a watering bowl. The platform has an opening extending through a central portion thereof. The watering bowl has a base and sidewalls, and is configured for being received in the opening. The watering bowl is removeably secured in the opening and aligned with an associated spigot for collecting water therein so that a pet may drink therefrom.

A method of watering a pet is also disclosed comprising the steps of: providing a platform configured for spanning a wash basin having a spigot, the platform having an opening extending through a central portion thereof; and a watering bowl having a base and sidewalls, the watering bowl removeably received in the opening; positioning the platform across the wash basin so that the watering bowl is aligned with the spigot; and opening the spigot so that water is collected in the watering bowl so that a pet may drink therefrom while standing on the platform.

### BRIEF DESCRIPTION OF THE DRAWINGS

FIG. 1 is a perspective assembly view of a pet watering apparatus according to an embodiment of the present invention positioned on a wash basin;

FIG. 2 is a top plan view of the support platform of FIG. 1;

FIG. 3 is a sectional view of the support platform taken along line 3-3 of FIG. 2 and viewed in the direction of the arrows;

FIG. 4 is a sectional view of the support platform taken along line 4-4 of FIG. 2 and viewed in the direction of the arrows;

FIG. 5 is a top plan view of a water container suitable for use with any of the disclosed support platform systems;

FIG. 6 is a side view of the water container of FIG. 5;

FIG. 7 is a perspective view of a support platform system according to another embodiment positioned on a sink, showing an exploded view of a water container and positioning pins of the system;

FIG. 8 is a top plan view of the support platform of FIG. 7;

FIG. 9 is a sectional view of the support platform taken along line 9-9 of FIG. 8 and viewed in the direction of the arrows;

FIG. 10 is a sectional view of the support platform taken along line 10-10 of FIG. 8 and viewed in the direction of the arrows;

FIG. 11 is a top plan view of a support platform system according to another embodiment, with telescoping sections partially shown in phantom; and

FIG. 12 is a sectional view of the support platform taken along line 12-12 of FIG. 11 and viewed in the direction of the arrows.

### DETAILED DESCRIPTION OF PREFERRED EMBODIMENTS

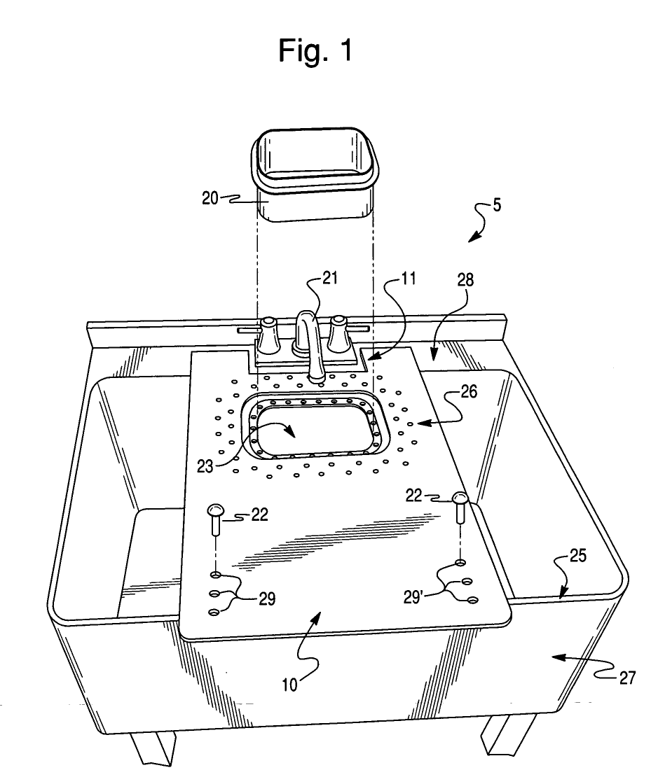

A pet watering apparatus 5 according to an embodiment of the present invention is best shown in FIG. 1. Apparatus 5 includes a platform 10 configured to rest on opposite edges 25, 28 of a wash basin 27, and to span wash basin 27 to provide adequate support for a small pet wishing to drink therefrom. Platform 10 preferably includes a cutout portion 11 extending into a perimeter edge and configured to fit around and accommodate a faucet assembly associated with a spigot 21 of wash basis 27. Cutout portion 11 helps to limit the side to side movement of platform 10. Platform 10 may be constructed as a single piece or from several pieces fitted together in a way that assures adequate support for a pet disposed thereon.

Platform 10 includes an opening 23 extending through a central portion thereof. Opening 23 is sized and shaped to receive a corresponding configured container 20, which acts as a watering bowl. Platform 10 preferably includes a plurality of holes 26 extending through the central portion thereof, preferably proximate opening 23. Holes 26 permit any water that may be splashed onto the upper surface of platform 10 to pass through and into wash basin 27, and be drained away via the associated plumbing.

Platform 10 also preferably includes at least a first plurality of holes 29 extending linearly and intermediate opening 23 and a perimeter edge of platform 10. Preferably, platform 10 includes a second plurality of holes 29′ also extending linearly and intermediate opening 23 and the perimeter edge of platform 10. Retaining pins 22 are provided, which are received in a selected one of holes 29, 29′. The end of each retaining pin 22 extends outwardly from an underside of platform 10, and is engageable with an inner surface of wash basin 27. In this way, retaining pin 22 ensures that platform 10 is maintained in a relatively fixed position, minimizing the possibility that platform 10 slips out of position and losing contact with and support from edge 28 of wash basin 27.

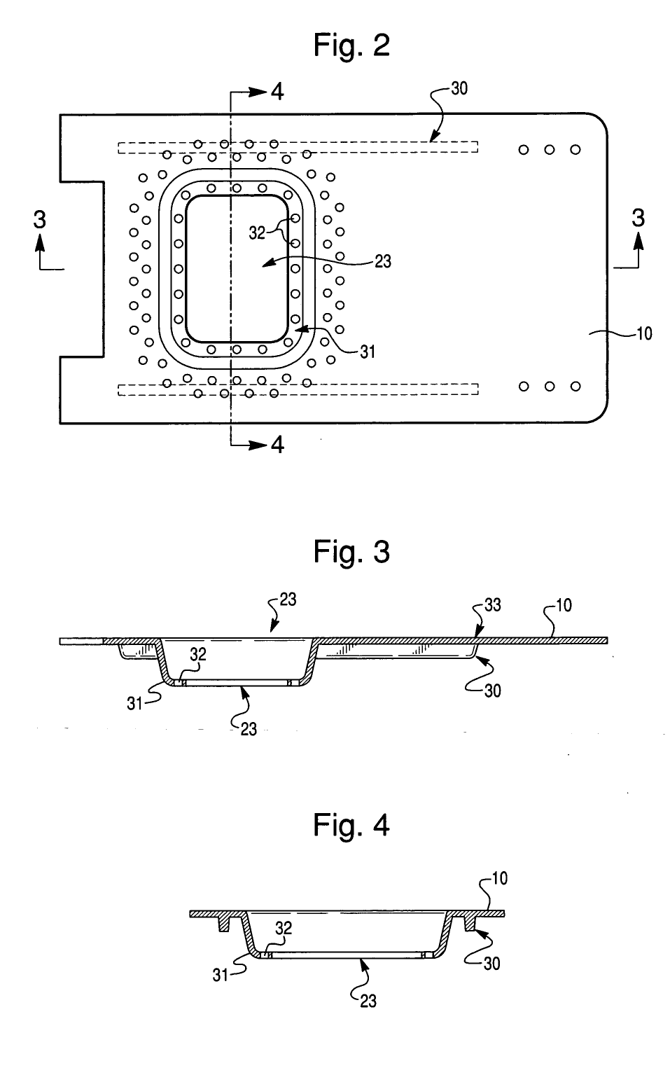

As best shown FIGS. 2, 3, and 4, platform 10 is preferably reinforced with one or more longitudinal supports 30 (shown in phantom) attached to either the upper surface or the underside thereof. Longitudinal supports 30 may be integrally formed with platform 10, such as by injection molding. Alternatively, longitudinal supports 30 may be affixed to platform 10 via associated fasteners or adhesive. Longitudinal supports 30 provide additional rigidity to platform 10, and may be configured as needed to support the weight of one or more small pets. Lateral supports may also be provided, as desired for additional stability and support.

Preferably, platform 10 includes depressed portion 31 surrounding and defining opening 23. Depressed portion 31 may catch any water splashed from container 20 during filling, or when water from spigot 21 overflows container 20. Depressed portion 31 may also catch any water that is splashed out by the pet during drinking. Depressed portion 31 preferably includes a plurality of holes 32 extending therethrough. Holes 32 in depressed portion 31 allow any spilled or overflow water to drain into wash basin 27.

The upper surface of platform 10 may be roughened or covered with a nonskid coating to minimize the possibility of the pet slipping when on platform 10, or when jumping onto or off of platform 10. In addition, the bottom surface of the platform 10 may be roughened or covered with a nonskid coating to minimize the possibility that the platform will slide relative to the supporting wash basin.

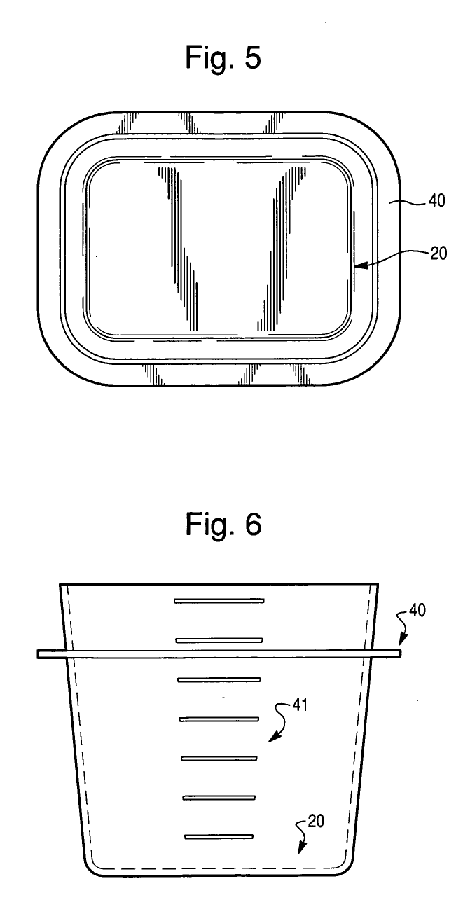

As shown in FIGS. 5 and 6, water container 20 is sized to fit into opening 23 (see FIGS. 1-4). Preferably, container 20 includes a flange, or retaining ring 40, extending outwardly from sidewalls of container 20. Retaining ring 40 may be attached to or manufactured as an integral part of container 20, and is larger than opening 23 so that container 20 is prohibited from slipping completely through opening 23. Alternative structures such as knobs, pins, blocks or other protrusions may also be provided, which support water container 20 at a desired position relative to the upper surface of platform 10.

Alternatively, container 20 may be configured to have a lower portion smaller than an upper portion proximate the opening, so that the upper portion is wedged into opening 23, thereby prohibiting water container 20 from slipping through opening 23. As viewed from the top, container 20 may be any of a variety of shapes including round, square, oblong or irregular, to assure that a portion is directly below and aligned with the spigot, and a substantial portion of the water surface retained in container 20 accessible to the pet for drinking. Container 20 may contain indentations, protrusions, or markings 41 to allow the pet owner to easily determine the amount of water consumed by the pet.

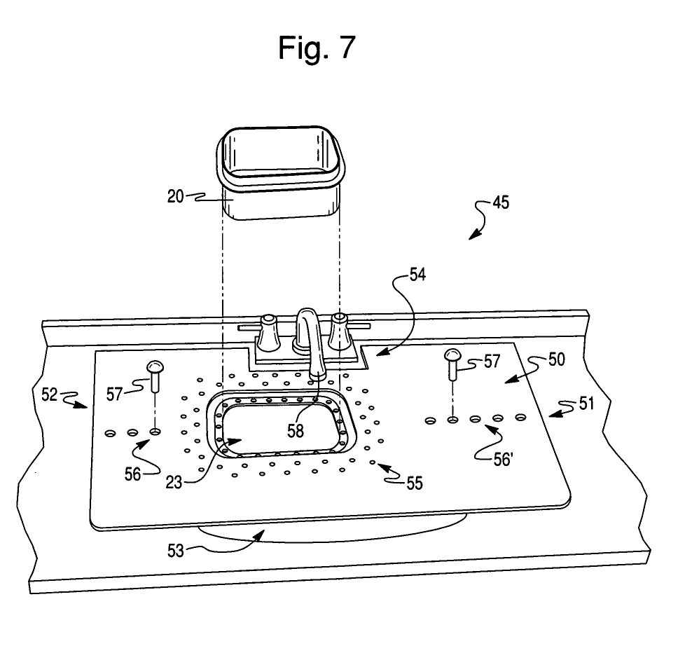

A pet watering apparatus 45 according to another embodiment is best shown in FIG. 7. Apparatus 45 includes a platform 50 which is designed to rest on opposite sides 51, 52 of a sink basin 53, spanning sink basin 53 to provide support for a small pet wishing to drink. A cutout portion 54 of platform 50 is configured to fit around and accommodate a faucet assembly associated with sink basin 53. Cutout portion 54 limits the side to side movement of platform 50 when disposed on sink basin 53. Note that platform 50 of apparatus 45 may also be used on a bathtub in a similar manner. Platform 50 may be constructed as a single piece or from several pieces fitted together in a way that assures adequate support to the pet.

Platform 50 includes opening 23 configured to accommodate container 20, as described above. Opening 23 may be disposed in a central portion of platform 50 so that the spigot 58 is aligned with the center of opening 23, or alternatively it may be aligned with but off-center of opening 23, as shown in FIG. 7. For some faucet assemblies, an off-center alignment of spigot 58 with opening 23 ensures that the pet has easy access to the water in the water container 20, unencumbered by the protruding spigot. The off center placement of opening 23 relative to spigot 58 may also allow the pet to stand closer to spigot 58 when accessing the flow of water directly from spigot 58.

Platform 50 preferably includes a plurality of holes 55 to allow water splashed or spilled on the upper surface of platform 50 to pass through and into sink basin 53 and be drained away by associated plumbing.

Platform 50 may also include first and second pluralities of holes 56, 56′ which accommodate cooperating retaining pins 57 as an additional mechanism for holding platform 50 in a desired position. Similar to holes 29, 29′ and associated pins 22, holes 56, 56′ and pins 57 minimize the possibly of platform 50 slipping from side to side. However, the first and second pluralities of holes 56, 56′ preferably extend linearly from opening 23 to opposite perimeter edges of platform 50, respectively, as shown in FIG. 7.

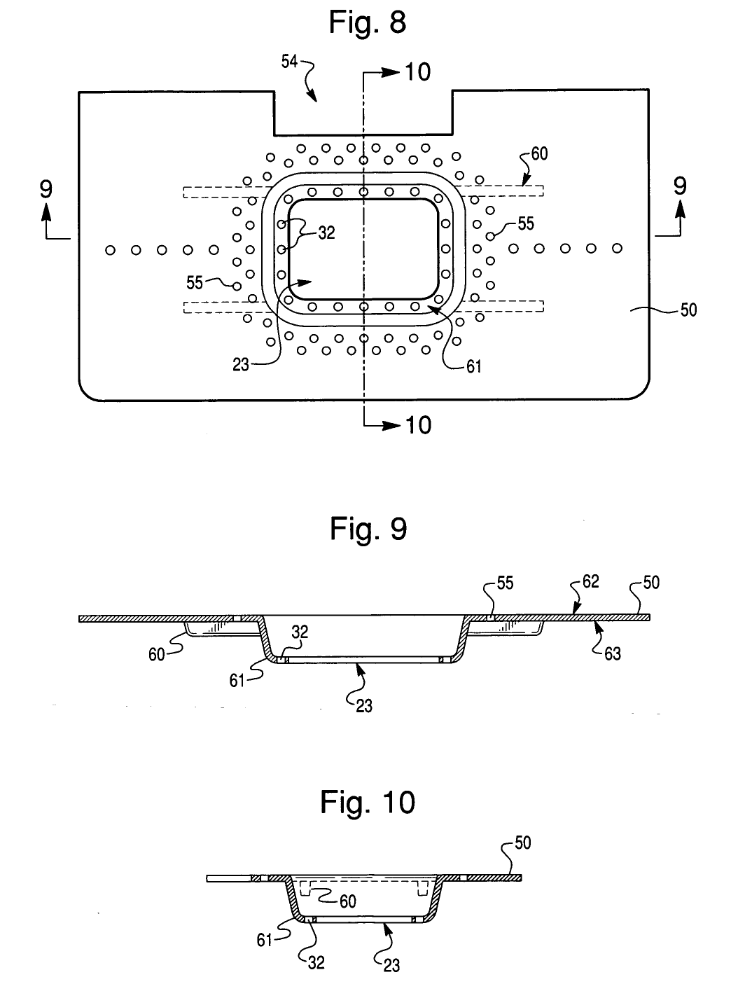

As best shown in FIGS. 8, 9, and 10, platform 50 may be reinforced as needed with longitudinal supports 60 (shown in phantom) to support the weight of one or more small pets. Longitudinal supports 60 may be attached to or manufactured as an integral part of platform 50. Longitudinal supports 60 may be disposed on either the upper surface or underside of platform 50. Alternatively or in addition, platform 50 may include lateral supports disposed on either the upper surface or underside of platform 50, as desired for stability and support.

Similar to depressed portion 31, platform 50 may include a depressed portion 61 surrounding and defining opening 23 for catching any water that may be splashed from water container 20 during filling, when the water is purged by a constant supply from the spigot 58, or that is splashed out by the pet during drinking. Holes 32 may be provided in depressed portion 61, which allow any spilled or overflow water to drain into the sink basin 53.

The upper surface of platform 50 may be roughened or be covered with a nonskid coating 62 to assure that the pet does not slide or skid while on platform 50, or when jumping onto or off of platform 50. The bottom surface of the platform 50 may be roughened or covered with a nonskid coating 63 to minimize the possibility that the platform will slide relative to the supporting sink basin.

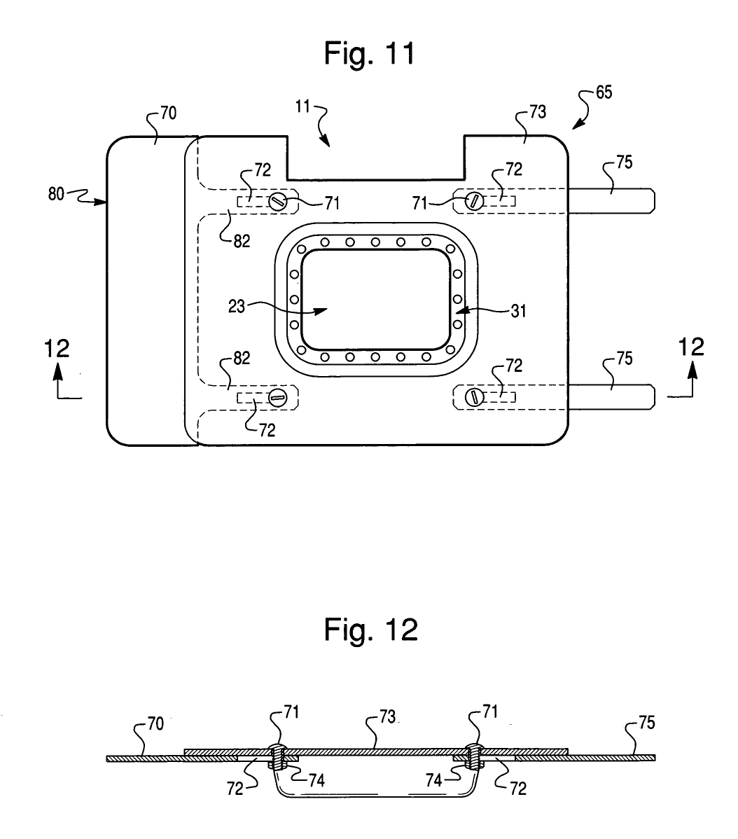

A telescoping platform 65 according to another embodiment is best shown in FIGS. 11 and 12. Telescoping platform 65 includes several interconnected sections that telescope to fit different size sinks, and permit packaging in different size cartons.

Telescoping platform 65 may include a primary section 73 having opening 23, cutout portion 11, and depressed portion 31, as described above. An extension panel 70 slideably secured to primary section 73 may be provided, which has a distal edge 80 moveable toward and away from opening 23. Preferably, extension panel 70 includes first and second elongate slots 72. Fasteners, such as bolts 71, extend through associated openings in primary section 73, through slots 72, and are retained therein via associated nuts 74. Extension panel 70 may be slid inwardly or outwardly as bolts 71 slide along slots 72, so that the overall length (or width) of telescoping platform 65 may be adjusted. Nuts 74 may then be tightened, thereby securing extension panel 70 to primary section 73 in a desired position. Slots 72 may be provided in protrusions 82 extending outwardly from the major portion of extension panel 70.

Alternatively or in addition, telescoping platform 65 may include one or more extension bars 75. Similar to extension panel 70, extension bars 75 include slots 72 which cooperate with corresponding bolts 71 and nuts 74, as described above.

Alternatively, multiple extension panels 70 or extension bars 75 may be provided, which telescope outwardly and away from primary section 73. It should be understood that the precise size and configuration of primary section 73, extension panel(s) 70 and/or extension bar(s) 75 may vary as required. Thus, in addition to the shapes of primary section 73, extension panel 70, or extension bars 75 disclosed in the figures, other shapes and methods of attachment such as hinges, braces, and sleeves are possible, so long as the joined portions span the sink and provide adequate support for the weight of the water bowl and the pet. Likewise, the precise size and shape of platform 10 (or 50) may vary as required for functional or marketing purposes. Thus, the generally rectangular shape of platform 10 (or 50), primary section 73 or extension panel 70 (or bars 75) disclosed in the figures is exemplary, and the disclosed invention is not so limited.

In addition, platform 10 (or 50, or primary section 73, extension panels 70 or extension bars 75) is preferably formed from a water resistant material, such as a polymer composite, Plexiglas, or the like. However, platform 10 may be formed from any rigid material, such as a fiberglass or cellulosic material and resin composite (e.g. plywood or fiberboard), or some rust-resistant metal.

It will be apparent to one of ordinary skill in the art that various modifications and variations can be made in construction or configuration of the present invention without departing from the scope or spirit of the invention. Further, aspects of one embodiment may be incorporated into another embodiment without departing from the scope or spirit of the invention. Thus, it is intended that the present invention cover such modifications and variations, and as may be applied to the central features set forth above, provided they come within the scope of the following claims and their equivalents.

I claim:

1. A pet watering apparatus for use with a wash basin having a spigot, the pet watering apparatus comprising:
a platform configured for spanning the wash basin, said platform having an opening extending through a central portion thereof; and
a watering bowl having a base and sidewalls, said watering bowl configured for being received in said opening, said watering bowl removeably secured in said opening and aligned with the spigot for collecting water therein so that a pet may drink therefrom.

2. The pet watering apparatus of claim 1, wherein said platform includes a depressed portion surrounding and defining said opening.

3. The pet watering apparatus of claim 2, further comprising a plurality of holes disposed in said depressed portion.

4. The pet watering apparatus of claim 1, wherein said platform includes a plurality of holes surrounding and proximate said opening.

5. The pet watering apparatus of claim 1, wherein said watering bowl includes a flange extending outwardly from said sidewalls proximate an upper edge thereof, said flange engaging an upper surface of said platform for removeably securing said watering bowl in a predetermined position within said opening.

6. The pet watering apparatus of claim 5, wherein said flange extends outwardly from said sidewalls on a plane substantially parallel to the plane of said upper edge.

7. The pet watering apparatus of claim 1, further comprising at least one longitudinal support attached to an underside of said platform.

8. The pet watering apparatus of claim 7, wherein said at least one longitudinal support and said platform are integrally formed.

9. The pet watering apparatus of claim 1, wherein said central portion includes a non-skid surface.

10. The pet watering apparatus of claim 1, wherein said watering bowl includes a plurality of reference marks for indicating an amount of water collected therein.

11. The pet watering apparatus of claim 1, wherein said platform includes a first plurality of spaced holes extending linearly and intermediate said opening and a perimeter edge of said platform.

12. The pet watering apparatus of claim 11, further comprising a first retaining pin receivable in a selected one of said first plurality of spaced holes, said first retaining pin having an end extending through said selected one of said first plurality of spaced holes and engageable with an inner surface of the wash basin for minimizing movement of said platform when disposed on the wash basin.

13. The pet watering apparatus of claim 12, wherein said platform includes a second plurality of spaced holes extending linearly and intermediate said opening and the perimeter edge of said platform.

14. The pet watering apparatus of claim 13, further comprising a second retaining pin receivable in a selected one of said second plurality of spaced holes, said second retaining pin having an end extending through said selected one of said second plurality of spaced holes and engageable with the inner surface of the wash basin for minimizing movement of said platform when disposed on the wash basin.

15. The pet watering apparatus of claim 14, wherein said first and second plurality of spaced holes extend outwardly from said opening toward a first end.

16. The pet watering apparatus of claim 14, wherein said first plurality of spaced holes extends outwardly from said opening toward a first end and said second plurality of spaced holes extends outwardly from said opening toward a second end opposite said first end.

17. The pet watering apparatus of claim 1, wherein said platform includes a cutout extending inwardly from a perimeter edge thereof, said cutout configured for surrounding a faucet assembly associated with the spigot.

18. The pet watering apparatus of claim 1, further comprising an extension panel slideably secured to a first side of said platform, said extension panel having a distal edge moveable toward and away from said platform for accommodating various sink sizes.

19. The pet watering apparatus of claim 18, wherein said extension panel includes at least one elongate slot, said extension panel slideably secured to said platform via a fastener extending through an opening therein and through said at least one elongate slot.

20. The pet watering apparatus of claim 1, further comprising at least one extension bar slideably secured to a first side of said platform, said extension bar having a distal end moveable toward and away from said platform for accommodating various sink sizes.

21. The pet watering apparatus of claim 20, wherein said extension bar includes at least one elongate slot, said extension bar slideably secured to said platform via a fastener extending through an opening therein and through said at least one elongate slot.

22. A method of watering a pet, comprising the steps of:
providing a platform configured for spanning a wash basin having a spigot, the platform having an opening extending through a central portion thereof; and a watering bowl having a base and sidewalls, the watering bowl removeably received in the opening;
positioning the platform across the wash basin so that the watering bowl is aligned with the spigot; and
opening the spigot so that water is collected in the watering bowl so that a pet may drink therefrom while standing on the platform.

23. The method of claim 22, comprising the further steps of:
providing a platform having at least a first plurality of spaced holes extending linearly and intermediate the opening and a perimeter edge of the platform, and a retaining pin receivable in a selected one of the first plurality of spaced holes;
inserting the retaining pin in a selected one of the first plurality of spaced holes so that an end of the retaining pin engages an inner surface of the wash basin, thereby minimizing movement of the platform on the wash basin.
